(19) United States
(12) Patent Application Publication
(10) Pub. No.: US 2003/0168889 A1
(43) Pub. Date: Sep. 11, 2003

(54) Method for making a ready to bond modular element and assembling method

(76) Inventors: Ahmet Comert, Chaineaux (BE); Dominique Petit, Blegny (BE); Marc Mertens, Spa (BE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/276,697

(22) PCT Filed: May 18, 2001
(86) PCT No.: PCT/EP01/05740

(30) Foreign Application Priority Data
May 18, 2000 (FR) 00/06399
May 24, 2000 (GB) 0012668.0
Jan. 24, 2001 (GB) 0101842.3

(51) Int. Cl. B62D 25/06

(52) U.S. Cl. 296/210

(57) ABSTRACT

The invention concerns a method for making a modular element, such as a motor vehicle roof or door, ready to be bonded onto a frame or other surface with a bonding bead in accordance with a bonding pattern, closed in particular, comprising the following steps: producing, in particular in a mould, a composite shape bonding bead reproducing the bonding pattern and having a specific cross-section, comprising a structural bead linked to a protected adhesive coating or capable of being activated and to the element. The invention also provides producing in a mould a homogeneous bonding bead having at least a protected adhesive surface or capable of being activated. The method for mounting the modular element consists in removing the protection or activating the adhesive coating and in pressing the modular element on the frame or like surface. The invention is applicable to car manufacture.

The present invention relates to a method of manufacturing a modular element, such as in particular a motor-vehicle roof or door module, ready to be bonded to a frame or other surface.

The current tendency, especially in the motor vehicle field, is toward what are called modular elements, especially for vehicle doors or roofs, which integrate, into a structural component, additional functions, especially various equipment items such as a lining or accessories. The purpose of this is to make it easier to assemble the vehicle, by reducing the number of assembling operations on an assembly line, the equipment items and/or accessories having been premounted in a separate unit or workshop.

Thus, WO 98/39170 teaches a motor-vehicle roof module which is composed of a sheet and an inner lining, into which module preassembled elements, such as a sunshield, opening roof panel and its mechanism, handle, ventilation grille, internal lighting, security elements, airbag, etc., can be integrated. The module may be fastened to the body of the vehicle exclusively by bonding or bonding together with screwing, the module being provided with housings intended to receive beads of adhesive.

U.S. Pat. No. 4,471,519 teaches how to bond a roof to an automobile body by depositing a bead of adhesive on the frame of the body, then by pressing on the roof in contact with the adhesive and curing the bead of adhesive for a time which is long enough for the assembly to reach the desired strength. However, this is still an operation carried out on the assembly line and contributing to the cumulative vehicle assembly time.

For the purpose of achieving the shortest possible assembly time for these modular elements, it would seem to be desirable to preequip them with fastening means that can be used on line in a short time.

The objective of the present invention is to provide a new way of preparing modular elements already provided with a fastening means, which modular elements can be stored for a certain period, to be able to be mounted directly on a frame or any other receiving surface in a small number of operations. The fastening means must be as complete as possible in order to allow definitive fastening that meets the desired strength criteria for the mounted assembly.

The term “modular element” is understood according to the invention to mean a part that integrates one or more additional functions that add to its own function(s), among which is the fastening function provided by a complete integrated fastening means.

This objective, together with others that will appear later, has been achieved with a method for manufacturing a modular element, such as a motor-vehicle roof or door module, ready to be bonded to a frame or other surface by means of a bonding bead made in an especially closed bonding pattern, characterized in that a composite bonding bead of shape reproducing the bonding pattern and of defined cross section is manufactured, comprising a structural bead bonded, on one side, to a layer of adhesive, which is protected or can be activated, and, on the other side, to the modular element.

The manufacture of the composite bead with a structural bead and a separate adhesive layer allows the dimensions of the bonding bead to be precisely set, thus making precise positioning of the assembled element easier. The dimensional characteristics of the bonding bead may be reproducibly obtained in the first manufacturing phase of the process according to the invention.

Furthermore, the composite construction of the bonding bead makes it possible itself to fulfill a certain number of additional functions, such as sealing and sound and impact attenuation, by adapting a specific portion of the bead.

Moreover, the manufacture of a composite bead makes it possible to guarantee the structural properties of the bead of adhesive by selection of the material of the structural bead.

Thus, in one advantageous embodiment, the structural bead has a tensile shear strength characterized by a tensile breaking stress of at least 7 MPa.

Producing a composite bead also makes it possible to use only the amount of adhesive that is strictly needed for fastening, allowing a substantial reduction in cost and assembly time compared with a solution in which it would be desired to form a bonding bead consisting only of adhesive and which would have structural properties. Likewise, the time needed to cure the adhesive so that it acquires structural properties has an unfavorable impact on the productivity. In this regard, the structural bead represents advantageously at least 50%, preferably at least 80 or 90%, of the volume of the composite bead.

In the composite bead, the structural bead may advantageously fulfill a sound damping function, damping out sound, thus contributing to the soundproofing of the assembly, or damping out shocks or stresses by absorbing any mechanical shocks or deformations. It may also compensate for the tolerances on the dimensions of a body. For this purpose, it may be advantageous for the structural bead to have suitable viscoelastic properties.

In one particular embodiment, the structural bead is made of a foamed material, which may be manufactured by a process in which a plastic is chemically foamed by means of a chemical agent (whether an additive or a reactive function of the plastic itself) that releases a gas which expands the plastic, or by a process in which a plastic is physically foamed by means of a gas mixed with the plastic in order to expand the latter.

Another type of foaming or expansion consists in adding expanded or expandable microspheres, for example of the EXPANCEL brand from Akzo Nobel, or glass microspheres, for example of the ARMOSPHERES brand from A.M.L. International or E-SPHERES from Envirospheres Pty Ltd.

Among materials that can be used to produce the structural bead, mention may be made by way of example of plasticized polyvinyl chloride, thermoplastic elastomers or polyurethanes, which may or may not be modified by an elastomer such as polyolefins or rubber, especially butyl, EPDM (ethylene-propylene-diene), nitrile, styrene-butadiene, etc.

The thermoplastic elastomers can be used in particular to form non-foamed structural beads.

In general, thermoplastic elastomers (TPEs) consist of blends of polymers or of block copolymers manifesting a thermoplastic phase and an elastomeric phase possibly chemically bonded together in the case of a copolymer. An example of this is the product with the brand name SANTOPRENE from AES, which consists of a polypropylene (PP)/EPDM blend, the EPDM being crosslinked in the form of nodules embedded in the continuous PP phase, with a variable PP weight ratio with respect to the EPDM. Also known are products based on block copolymer chains with elastomer blocks, especially isoprene or butadiene blocks, hydrogenated or otherwise, which are linked to thermoplastic blocks, especially polystyrene blocks, for example the products with the brand name KRATON from Shell.

Also known are thermoplastic urethanes (TPUs) available in the form of a nonreactive polymer obtained from several polyol sources, at least one of which forms a block having thermoplastic properties and at least one other forms a block having elastic properties. Examples are the products PEARLTHANE or PEARLCOAT from Merquinsa, or ELASTOLLAN from Elastogran. It is also possible to form a bead based on polyurethane with a great variety of commercially available reactive compositions of the one-component or two-component type. As examples, mention may especially be made of one-component compositions based on a polyurethane prepolymer with a polyester, polyether, polycaprolactone, polyolefin or polysiloxane backbone. A prepolymer with isocyanate end groups cures in the presence of moisture with a certain foaming tendency; a prepolymer having siloxane end groups cures in the presence of moisture without foaming. An example of a commercial product is BETASEAL from Gurit Essex. These polyurethane compositions may be modified by an elastomer, especially a nitrile, SBR or butyl rubber, or a thermoplastic elastomer or a polymer having a certain flexibility but which is not crosslinkable, such as polyolefins or plasticized PVC. Examples of such compositions that can be used for manufacturing foamed or cellular materials, especially by the addition of a foaming gas, are described in EP-A-0 326 704 or EP-A-0 930 323.

The material of the structural bead may furthermore contain organic or mineral fillers, such as talc, silica, calcium carbonate, alumina, etc.

Advantageously, the structural bead has a density of less than 2.5, especially around 0.8 to 2.5 in the case of noncellular materials or 0.1 to 1 in the case of foamed or cellular materials.

The composite bead also includes a layer of adhesive intended to bond the modular element to the frame or other surface. This layer of adhesive is chosen so as to remain inert during the storage period and be able to be activated at the time of assembly.

In particular embodiments, the layer of adhesive consists of an adhesive which is thermally activatable, photoactivatable, chemically activatable, moisture-reactive and/or has a permanent tack. The same adhesive may have several of these properties combined.

Advantageously, the layer of adhesive consists of an adhesive protected by a peelable film.

Thermal activation generally requires exposing the adhesive to temperatures exceeding room temperature in any season in temperate climates; in general, it is unnecessary to provide a particular protection for neutralizing the adhesive during the storage period. Likewise, an adhesive that can be activated by a defined chemical reactant is generally not sensitive to the ambient atmosphere. An adhesive that can be photoactivated by visible light may advantageously be protected from light by an opaque film. A moisture-reactive adhesive must be protected by a moisture barrier film in order to be able to be stored for a long time. An adhesive having permanent tack must be protected from any contact during its storage. In all cases, a protective film, even if it is not obligatory, is desirable in order to prevent the surface of the adhesive being contaminated with dust which could hamper the final adhesive bonding.

As regards film, a plastic film may be used, especially a polyethylene, polyester, polyvinylchloride or polyvinylidene chloride film, which may or may not be coated with a layer of silicone, especially fluorosilicone, in order in particular to protect a silicone-based adhesive layer. The film may also be reinforced by a layer of metal, especially aluminum.

Thermally activated adhesives comprise resins of the epoxy, polyurethane, polyether or polyester, especially polyacrylic, oxyalkylene or vinyl, type and thermoplastics of polyolefin, especially polyethylene or polypropylene, or polyamide type. The layer of adhesive may advantageously consist of a hot-melt adhesive, known hot-melt adhesives including butyl, especially styrene-butadiene, rubbers, ethylene/vinyl acetate copolymers (EVA), polyamides, polyaminoamides, or derived copolymers, and polyurethane-based compositions. The adhesive may contain heat-activated crosslinking catalysts or curing additives.

Reactive or moisture-curing adhesives may be chosen from polyurethane prepolymers having blocked or unblocked isocyanate end groups, or silanols, silicones and polymercapto compounds.

Chemically activatable adhesives may especially be the reactants curing by oxidation, or compositions containing an adhesive and an encapsulated or heat-activatable curing catalyst.

As regards the use of the additive for forming said layer of adhesive, it is advantageous to use a hot-melt adhesive capable of being used in the molten state, or a liquid adhesive or an adhesive in a liquid vehicle, especially as an organic solution or as an aqueous suspension/dispersion which forms an adhesive layer by evaporation of the solvent vehicle or diluent.

Advantageously, the adhesive is chosen to be compatible with the material of the structural bead, whether it can be envisaged to treat the internal face of the layer of adhesive and/or the surface of the structural bead with adhesion promoters or primers, or even to interpose another adhesive between the structural bead and the layer of adhesive.

The bonding of the layer of adhesive to the structural bead may advantageously be reinforced by the fact that at least one of the surfaces of the structural bead and of the layer of adhesive which are in contact with each other is textured. The relief of the texturing has the effect of increasing the area of contact between these two parts of the composite bead and therefore of increasing the adhesion.

Advantageously, the method according to the invention allows the composite bead to be shaped so as to reproduce the bonding pattern, advantageously when this pattern is a closed curve which follows in particular at least part of the periphery of the modular element. The method furthermore also makes it possible to shape the cross section of the composite bead so that it fits perfectly into the space that is reserved for it in the final assembling operation.

According to one embodiment, the structural bead is formed as a single piece with the modular element.

According to another embodiment, a composite bonding bead is firstly manufactured, which comprises a structural bead bonded, on one side, to the layer of adhesive and having, on the other side, a bonding surface and then the composite bead is bonded to the modular element via the bonding surface. In this case, the preformed composite bead may be provided with an adhesive surface as bonding surface on that side on which the modular element is presented, or else it is the modular element itself which has an adhesive surface; optionally, the modular element adheres to the bead because said bead (or at least part of the latter) is formed at the contact with the composite bead from a substance adhering to said bead.

According to all the above embodiments, the composite bead may be formed by depositing the layer of adhesive in a cavity of a mold and by molding the structural bead in the cavity of the mould by depositing a suitable moldable material on the layer of adhesive in the mold cavity. When the structural bead is formed as a single piece with the modular element, it is therefore possible to mold the modular element (or at least a portion of the latter) directly on the layer of adhesive so as to produce the modular element (or the modular element portion) and the composite bead simultaneously.

When the composite bead is formed separately from the modular element, it is possible either to transfer the composite bead to a prefabricated modular element or to mold the modular element in contact with the composite bead in said cavity. The structural bead may then be cured in the mold and/or after the composite bead has been transferred to the modular element.

The moldable material may be deposited in a closed mold by injecting a liquid. A process may also be carried out in a mold cavity by extrusion (or another suitable delivery method) of a viscous or pasty material, with the aid of moveable delivery means, the mold being stationary, or else stationary delivery means, the mold then being moveable.

The molding technique also applies to the production of a homogeneous (noncomposite) adhesive bead reproducing the bonding pattern, this bead being protected or activatable on one face and having a surface for bonding to the modular element. This homogeneous bonding bead may be obtained in a mold cavity, possibly containing a protective film, by injection molding or by extrusion of a viscous material into the cavity. This aspect, in which the bonding bead is not a composite bead but a homogeneous bead, also lies within the scope of the invention and all the arrangements or variants described or claimed above or subsequently in the present application relating to the forming of the structural and/or composite bead in a mold and transfer to the modular element also apply to the forming of an adhesive bead from a suitable moldable or extrudable adhesive material.

In particular if the adhesive bead is protected by a peelable film, the moldable adhesive material is advantageously chosen from those in which the modulus of elasticity in the uncrosslinked state is sufficient to allow the film to be peeled off without tearing the material of the bead.

Such materials comprise, in particular, moisture-crosslinkable systems that can be protected by a moisture barrier film, especially systems of the one-component, preferably thermoplastic polyurethane type, possibly modified by an elastomer. An advantageous system is a polyurethane prepolymer having a backbone of the polyester, polyether or polyolefin type, obtained for example from a polyol and a polyisocyanate, at least one of which has a polymeric or oligomeric backbone as mentioned above.

As a variant, the composite bead may be formed by depositing a preformed, especially premolded, structural bead on the layer of adhesive in the mold cavity, the superposition of the two parts in another mold allowing the precise shape of the composite bead to be controlled. In this variant, the preformed structural bead may be an integral part of a modular element (or a portion of the latter) manufactured by molding.

In both cases, the layer of adhesive may be deposited in the mold in the form of a preformed strip or of reactive, liquid or viscous material. The adhesive may also be provided with the structural bead by coextrusion.

Preferably, a peelable protective film is applied beforehand to the surface of the mold cavity as mold release agent. This peelable film may advantageously constitute the protection for the layer of adhesive. In particular, the film may have moisture barrier properties in order to protect a layer of moisture-reactive adhesive.

In order to apply a composite bead produced separately, an adhesive may be placed between the composite bead and the modular element. This adhesive may be identical to or different from that used to form the composite bead. In one particular embodiment, the layer of adhesive of the composite bead completely encapsulates the structural bead and constitutes both the agent for bonding the composite bead to the modular element and for to the modular element to the frame or other application surface.

Such a composite bead may be manufactured especially by coextruding the adhesive all around the structural bead, it being possible for the coextrusion product to be deposited in a mold cavity preequipped with a protective film, in order to assume its final shape. The term “coextrusion” is understood here to mean both the formation of the structural bead simultaneously with its encapsulation by means of an extrusion head fed with two extrudable materials, and the application of adhesive material in an extrusion head through which a preformed structural bead, especially one preformed by extrusion, passes.

In another embodiment, the material of the structural bead is itself chosen to be adhesive and to bond to the modular element in the uncured or partially cured state or after activation, especially thermal activation.

A preferred manufacturing process consists in depositing a layer of adhesive, and then a moldable material which constitutes the structural bead, in a mold cavity advantageously preequipped with a protective film, and then presses the modular element against the structural bead in order to bond the structural bead to the modular element. Next, the composite bead may possibly be at least partly cured in this mold thus closed by the modular element, before the modular element to which the composite bead is fastened, including as the case may be its protective film, is removed. The curing of the structural bead may advantageously be carried out or completed outside the mold by cooling or by reaction with the moisture of the air.

Such a method of deposition by transfer of a molded bead made of a polyurethane modified by an elastomer is described in the document U.S. Pat. No. 5,164,136.

The method according to the invention allows the mass production of modular elements ready to be assembled by bonding, this manufacture possibly being automated. The final assembly of these modular elements is very rapid and meets the need to reduce the assembly time for assemblies such as motor vehicles.

The subject of the invention is also a method of mounting a modular element, such as a motor-vehicle roof or door module, ready to be bonded to a frame or other surface by means of a bonding bead deposited in a bonding pattern, manufactured as described above, characterized in that the protection is removed or the layer of adhesive is activated, and the modular element is applied to the frame or other surface.

Further details and advantageous features will become apparent below on reading the description of illustrative, but nonlimiting, examples of the invention, with reference to the appended drawings in which:

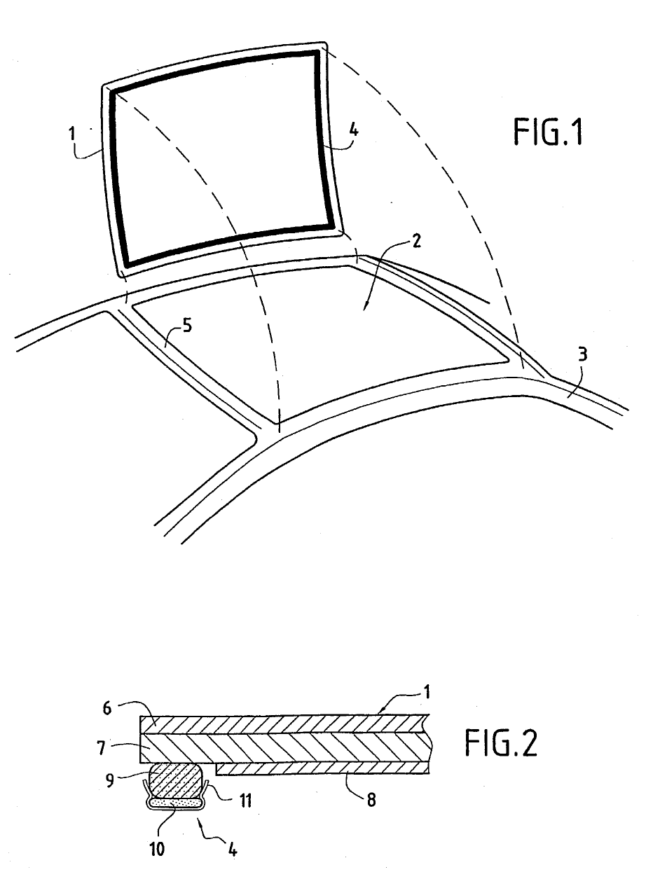

FIG. 1 shows a perspective view of the assembling of a roof module on a motor vehicle body;

FIG. 2 shows a sectional view of the border region of the roof module equipped with a bonding bead;

FIG. 3 illustrates the manufacture of the bonding bead;

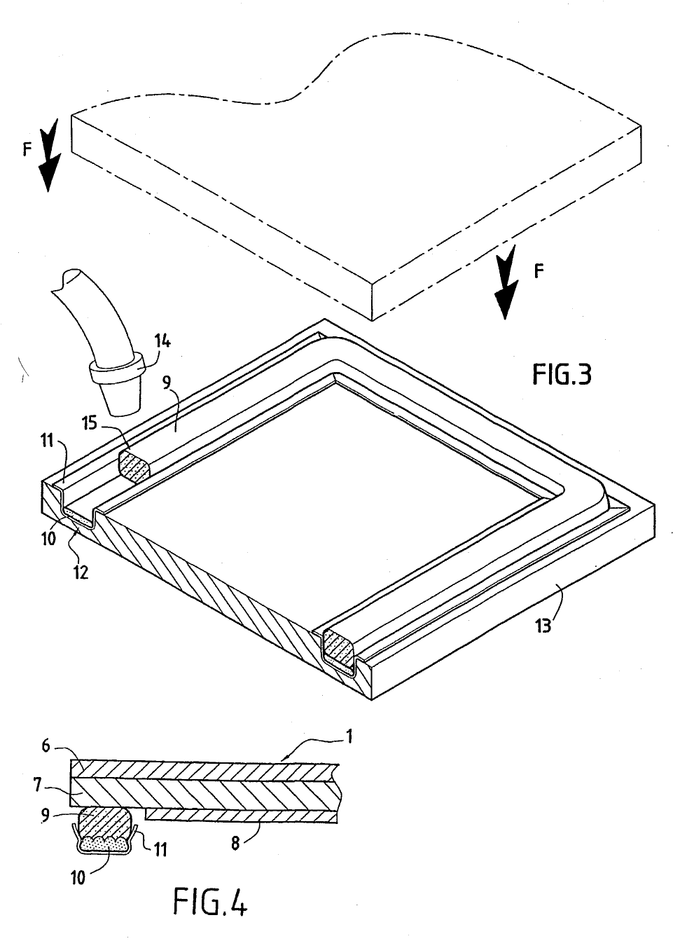

FIGS. 4, 5, 6 and 7 show two variants of the bonding bead and their manufacture; and

FIG. 8 shows another aspect of the invention with a homogeneous bonding bead.

It should firstly be pointed out that for the sake of clarity the relative portions between the various elements shown are not respected.

FIG. 1 shows a perspective view of the upper part of a motor vehicle equipped with a roof module 1 attached to an opening 2 in the body 3.

The roof module 1 is shown in the nonassembled position in order to reveal its face turned toward the interior of the vehicle. To simplify examination of the figure, no accessory or equipment has been shown on the roof module, but it goes without saying that all the usual equipment items, such as a sunshield, etc. may be integrated into this module.

The roof module 1 is mounted on the body 3 via a bonding bead 4 which is brought into contact with a flange 5 of the body opening. In this case, the bonding pattern is in the form of a closed frame hugging the periphery of the roof module. The bonding bead 4 ensures that the module 1 is fastened to the body 3 and can also fulfill a function such as the sealing between the internal space and the external space that are bounded by these two parts.

The structure of the bead 4 is a composite structure according to the invention and can be seen in FIG. 2, which also shows the structure of the module 1. In this figure, the module is shown as it is before being mounted on the vehicle.

In the embodiment shown, the module 1 has a sandwich structure with an outer sheet 6, an intermediate substance 7 and an inner lining 8. The bonding bead is placed around the periphery of the module 1 on or along side the lining 8.

The composite bead is formed from a structural bead 9 bonded to the module 1 and from a layer of adhesive 10 fastened to the structural bead and protected by a film 11. The structural bead 9 has a calibrated cross section according to the permitted separation between the module 1 and the flange 5. In this case, the cross section shown is approximately circular, but it may be of any other shape, especially one suited to the specific shape of the flange 5. To fulfill the sealing function, and possibly to compensate for the body manufacturing tolerances, the structural bead 9 is advantageously made of a viscoelastic material, such as the product with the brand name BETASEAL from Gurit Essex, preferably with a density of about 1, favorable to the strength of the assembly.

On the opposite side from the module, the structural bead 9 is provided with an adhesive layer 10 covering at least part of the surface of the bead 9. The layer 10 has approximately the shape of a substantially flat strip of variable thickness. Advantageously, as small an amount of adhesive 10 as possible is used to ensure effective bonding, whereas the structural bead 9 occupies at least about 50% of the volume of the composite bead 4. A preferred adhesive material is an adhesive with permanent tack or else a moisture-curing polyurethane. In general, the purpose of the film 11 is to prevent, during the storage period on the premises of the module manufacturer or of the automobile manufacturer, dust from contaminating the bonding bead and to prevent any contact with a surface other than the final assembly surface which could damage the layer of adhesive 10. The function of the film is also to protect the layer of adhesive from the external conditions, especially moisture, light and oxygen, liable to prematurely activate the adhesive 10.

The manufacture of the composite bead is illustrated in FIG. 3. Placed in the cavity 12 of a mold 13 is a film 11 whose face in contact with the mold (which will be the external face of the film once the bead 4 has been completed) may be made of polyethylene in order to act as a release agent for the molded material. Deposited on the internal face of the film 11 is a layer of adhesive 10 in the form of a strip that can be unreeled or else in the form of a fluid or viscous material, especially a hot-melt adhesive in the molten state or a liquid adhesive or an adhesive in the form of an organic solution or aqueous dispersion, the solvent or diluent of which is evaporated, which layer of adhesive is shaped in the cavity. Next, the material of the bead 9 is deposited on the layer of adhesive 10, for example by means of an extrusion nozzle 14 which is moved along the entire length of the cavity 11 in a closed circuit. In this way, it is possible to form a bead in the shape of a frame without any discontinuity and therefore resulting in no loss of sealing. The nozzle 14 may have a calibrated cross section in order to give a preliminary shape to the material of the bead 9, which ends up being shaped in the cavity 12 of the mold 13.

As soon as the material of the bead 9 has been deposited, the composite bead may be fitted onto the roof module 1, by transferring it onto the latter: the roof module 1, depicted by the dot-dashed line is pressed (in the direction of the arrows F) against the surface 15 of the not yet cured bead 9 and the material adheres spontaneously to the surface of the module. As a variant, an additional layer of adhesive, which may or may not be identical to that of the layer 10, may be applied to the surface of the cured or uncured bead 9 (if the material of the structural bead 9 does not adhere spontaneously to the material of the module 1). It is this second layer that then forms the adhesive surface 15 of the bead 9.

After an application time varying in length depending on the materials employed, the roof module 1 can be removed from the surface of the mold with the composite bead 4 bonded to its surface. The film 11 is also extracted from the mold cavity and remains attached to the layer of adhesive 10 that it immediately protects from dust and/or moisture.

The module 1 thus equipped with the bonding bead 4 may be held for a time long enough for the curing or the acquisition of the structural properties of the bead 9, and then stored awaiting its use for mounting on a vehicle.

Mounting takes place simply by removing the protective film 11, after which the bead 4 is pressed into contact with the flange 5. With a thermally activatable adhesive, the layer of adhesive may firstly be heated, especially by an infrared source, or else the module 1 may be put into place against the flange 5, followed by heating to raise the bonding bead to the temperature needed to activate the adhesive, for example by heating the flange 5 from inside.

FIG. 4 shows an alternative embodiment of the composite bead 4, in which that surface of the layer of adhesive 10 which bonds to the structural bead 9 is textured so as to increase the area of contact between these two parts of the composite bead. Such a layer of adhesive may especially be produced by depositing an adhesive material in the cavity 12 using a nozzle 14 of appropriate cross section. The composite bead is then obtained preferably by extruding a viscous or pasty material onto the textured surface of the layer of adhesive 10, as shown in FIG. 5. The extruded material of the bead 9 follows the contour of the textured face of the layer 10 over a contact area greater than that with a flat contact, hence resulting in better adhesion.

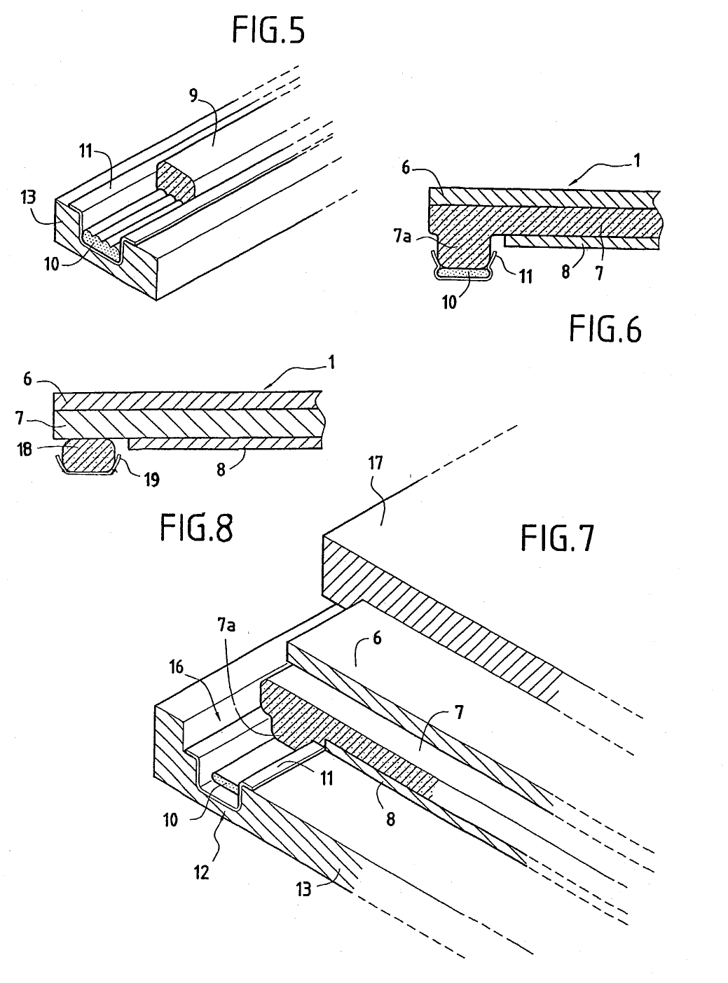

FIG. 6 shows an alternative embodiment in which the composite bead makes use of a structural bead 7a formed as a single piece with the layer 7 of the modular element.

The manufacture of this embodiment is illustrated in FIG. 7.

In this case a lower mold 13 is used, this having a cavity 12 similar to that of the previous embodiment, hollowed out at the bottom of a first cavity 16 which extends over almost the entire surface of the mold 13.

As previously, the film 11 and the adhesive 10 are deposited in the cavity 12 of the lower mold 13. The lining coating 8 is then applied to the central part of the cavity 16 of the mold 13.

The integral mass of intermediate material 7, such as polyurethane, is deposited in the cavity 12 and on the lining 8 in the cavity 16.

The sheet 6 is then applied and the whole assembly is pressed with an upper mold 17. The module and the composite bonding bead are thus formed simultaneously.

In an alternative embodiment, a structural bead 9 may be formed by depositing in the cavity 12 a first polyurethane having a high degree of viscoelasticity and the intermediate mass 7 is then formed with a more rigid second polyurethane.

In another alternative embodiment, the intermediate mass 7 may be formed by injecting material into the cavity formed by the two half-molds 13 and 17 in which were placed beforehand, on one side, the film 11, the layer of adhesive 10 and the lining 8 and, on the other side, the sheet 6.

FIG. 8 illustrates another aspect of the invention in which the modular element is preequipped with a homogeneous, protected or activatable, bonding bead. The roof module 1 has a structure identical to that of the module in FIG. 2 or FIG. 4. It is provided with a bonding bead 18 placed around the periphery of the module on or alongside the lining 8.

The bonding bead 18 is bonded to a first face at the module 1 and is protected on another face by a film 19, the protected face being adhesive after the film has been removed.

For this purpose, the bead 18 may consist of a moisture-crosslinkable adhesive, the film 19 having a moisture barrier function, for example made of low-density polyethylene. The adhesive material that can be used may be chosen from among systems based on polyurethane, advantageously thermoplastic polyurethane, optionally modified by at a polymer, especially an elastomer, in order to give the adhesive the desired mechanical properties. Most particularly preferred among these materials are polyurethane prepolymers having a polymeric or oligomeric, especially polyether and/or polyester, backbone. A moisture-crosslinkable thermoplastic polyurethane composition suitable for this use may be obtained by the hot reaction of 2 parts of a polyester diol sold under the brand name DYNACOLL® 7231 by Degussa-Huls with 1 part of a polyether-based isocyanate prepolymer sold under the brand name LUPRANAT® MP130 by BASF.

The manufacture of the bead 18 takes place in a manner similar to that described above with reference to FIG. 3. A film denoted here by the reference 19 is placed in the cavity 12 of a mold 13, that face of the film which is in contact with the mold (which will be the external face of the film after the module has been extracted from the mold), advantageously made of polyethylene, may serve as release agent for the molded material. The material of the bead 18 is deposited on the internal face of the film 19, for example by means of an extrusion nozzle 14. The rest of the operations is similar to that explained in the case of the description of FIG. 3.

In particular, transfer of the bead 18 to the module may take place by the module being pressed against the bead still having an adhesive upper face for bonding to the module, it being possible for the curing or setting of the material of the core of the bead to be achieved by keeping the assembly in the mold or preferably, after the module to which the bead now adheres has been extracted from the mold, by simply exposing the free faces of the bead to the ambient moisture or to a controlled humidity.

In another alternative embodiment, the bead 18 may be coated on its upper face with another protective film similar to the film 19, and then extracted from the mold in order to undergo a curing or setting treatment. Application of the bead to the module 1 may then take place in a separate station where the second protective film is removed in order to expose an adhesive surface to the module.

In another alternative embodiment, the adhesive may be chosen from among thermally activatable materials, especially hot-melt adhesives, or by chemically activatable materials. It is therefore no longer essential to provide the protective film 19, although this is still preferred in order to protect the activatable surface from any dust or dirt liable to counteract the activation and/or adhesion of the activated face.

The invention has been described in the particular case of the manufacture of a roof module ready to be bonded to a frame, but it applies to the production of any other modular element intended to be assembled by bonding to a body element or the like. Thus, production of decorative, protective or other components, possibly provided with additional functionalities, ready to be bonded to a complementary component with an assembling surface not necessarily in the form of a frame may be envisioned.

1. A method for manufacturing a modular element (1), such as a motor-vehicle roof or door module, ready to be bonded to a frame or other surface by means of a bonding bead (4) made in an especially closed bonding pattern, characterized in that a composite bonding bead (4) of shape reproducing the bonding pattern and of defined cross section is manufactured, comprising a structural bead (9) bonded, on one side, to a layer of adhesive (10), which is protected (11) or can be activated, and, on the other side, to the modular element (1).

2. The method as claimed in claim 1, characterized in that the structural bead (9) has a tensile strength of at least 7 MPa.

3. The method as claimed in claim 1 or 2, characterized in that the structural bead (9) represents at least 50% of the volume of the composite bead.

4. The method as claimed in one of claims 1 to 3, characterized in that the structural bead (9) has viscoelastic properties.

5. The method as claimed in one of claims 1 to 4, characterized in that the structural bead (9) is made of a foamed material.

6. The method as claimed in claim 5, characterized in that the structural bead (9) is based on a thermoplastic elastomer or a polyurethane, which may or may not be modified by an elastomer.

7. The method as claimed in claim 5 or 6, characterized in that the structural bead (9) has a density of 0.1 to 2.5.

8. The method as claimed in one of the preceding claims, characterized in that the layer of adhesive (10) consists of a thermally activatable, photoactivatable or chemically activatable adhesive.

9. The method as claimed in any one of claims 1 to 7, characterized in that the layer of adhesive (10) consists of an adhesive that has a permanent tack or is moisture-reactive, protected by a peelable film.

10. The method as claimed in any one of the preceding claims, characterized in that the layer of adhesive (10) consists of a hot-melt adhesive or is formed from a liquid adhesive or an adhesive in a liquid vehicle.

11. The method as claimed in any one of the preceding claims, characterized in that at least one of the surfaces of the structural bead (9) and of the contacting layer of adhesive (10) is textured.

12. The method as claimed in any one of the preceding claims, characterized in that the structural bead (9) is formed as a single piece with the modular element (1).

13. The method as claimed in any one of claims 1 to 11, characterized in that a composite bonding bead (4) is firstly manufactured, which comprises a structural bead (9) bonded, on one side, to the layer of adhesive (10) and having, on the other side, a bonding surface (15) and in that the composite bead (4) is then bonded to the modular element (1) on the bonding surface (15).

14. The method as claimed in claim 13, characterized in that the bonding surface is an adhesive surface (15).

15. The method as claimed in claim 13, characterized in that at least one part (7) of the modular element (1) is formed at the contact with the bonding surface from a substance adhering to the latter.

16. The method as claimed in any one of the preceding claims, characterized in that the composite bead (4) is formed by depositing the layer of adhesive (10) in a cavity (12) of mold (13) and by molding the structural bead (9) in the cavity (12) of the mold.

17. The method as claimed in claim 16, characterized in that the structural bead (9) is cured in the mold and/or after the composite bead (4) has been transferred to the modular element (1).

18. The method as claimed in one of claims 1 to 15, characterized in that the composite bead (4) is formed by depositing a preformed structural bead (9) on the layer of adhesive (10) in the mold cavity (12).

19. The method as claimed in any one of claims 16 to 18, characterized in that the layer of adhesive (10) is deposited in the mold in the form of a preformed strip or of reactive, liquid or viscous material.

20. The method as claimed in any one of claims 16 to 19, characterized in that a peelable protective film (11) is applied to the surface of the mold cavity (12) as mold release agent.

21. The method as claimed in claim 20, characterized in that the film (11) is a moisture barrier in order to protect a layer of moisture-reactive adhesive (10).

22. A method of manufacturing a modular element (1), such as a motor-vehicle roof or door module, ready to be bonded to a frame or other surface by means of a bonding bead (4) made in an especially closed bonding pattern, characterized in that an adhesive bead (18) of shape reproducing the bonding pattern and of defined cross section is manufactured, the bead having at least one protected (19) or activatable adhesive face, by molding an adhesive material in the cavity of a mold.

23. The method as claimed in claim 22, characterized in that a molded adhesive bead (18) having at least two protected or activatable adhesive faces is manufactured, one of said faces being intended to be brought into contact with the modular element after activation or removal of the protection.

24. A method of mounting a modular element (1), such as a motor-vehicle roof or door module, ready to be bonded to a frame (5) or other surface by means of a bonding bead (4) deposited in a bonding pattern, manufactured as claimed in any one of claims 1 to 23, characterized in that the protection (11) is removed or the layer of adhesive (10) is activated, and the modular element (1) is applied to the frame (5) or other surface.
